(19) United States
(12) Patent Application Publication
(10) Pub. No.: US 2026/0358671 A1
(43) Pub. Date: Nov. 12, 2026

(54) POCKELS MATERIAL ELECTRO-OPTIC DEVICE WITH EXTENDED ELECTRODES

(71) Applicant: Lumiphase AG, Stäfa (CH)

(72) Inventors: Lukas Kranz, Luzern (CH); Lukas Czornomaz, Kilchberg (CH)

(21) Appl. No.: 19/515,670

(22) PCT Filed: Sep. 4, 2024
(86) PCT No.: PCT/IB2024/058598

§ 371 Date: Mar. 2, 2026

Related U.S. Application Data
(60) Provisional application No. 63/581,013, filed on Sep. 7, 2023.

(51) Int. Cl. G02F 1/225; G02F 1/21

(52) U.S. Cl. CPC G02F 1/2255; G02F 1/212

(57) ABSTRACT

An electro-optic device and method for fabricating same involves etching recessed contacts into a Pockels layer such as by partially removing BTO material, within the contact regions, and then forming the metal electrodes into the etched recesses. Ideally this recessed contact etching results in rounded corners in the BTO to minimize electric field crowding.

### RELATED APPLICATIONS

This application claims the benefit under 35 U.S.C. § 119(e) of U.S. Provisional Application No. 63/581,013, filed on Sep. 7, 2023, which is incorporated herein by reference in its entirety.

### BACKGROUND OF THE INVENTION

A Mach-Zehnder (MZ) modulator is a type of interferometer used for modulating the amplitude of an optical signal. A waveguide splitter carries the input light and splits into two separate waveguides forming a ‘Y’ junction. One or both arms of the Y-junction contain a phase modulator structure that is used to change the refractive index thereby modulating the phase of light travelling through that arm. A waveguide combiner interferes the light from the two arms. The amplitude is controlled by the constructive or destructive interference.

MZ modulators can be fabricated in Pockels materials such as barium titanate (BaTiO₃, BTO), lithium niobate (LiNbO₃, LN), Lead Zirconate Titanate (PZT), and silicon-organic hybrid (SOH). These materials exhibit a change of their refractive index under an applied electric field (also known as the Pockels effect). For example, thin films of Lead Zirconate Titanate (PZT) can be grown on a silicon enabling high speed Pockels modulation on SiN waveguide. SOH modulators combine the advantages of large-scale silicon photonic integration with the extraordinarily high electro-optic (EO) coefficients obtained by molecular engineering of organic materials.

In Pockels effect-based MZ modulators, the integration of electrodes is a crucial aspect of their design. These modulators utilize the Pockels effect, which involves the modification of the refractive index of a material in response to an applied electric field.

Electrodes are used to apply the electric field across the Pockels material, inducing the Pockels effect. The design can include various electrode geometries, such as interdigitated electrodes or strip electrodes, depending on the desired modulation characteristics.

The electrode fabrication process involves depositing metal layers onto the substrate and typically in via holes formed in top cladding layers using techniques like photolithography and metal deposition.

### SUMMARY OF THE INVENTION

Pockels material such as BTO, LN, PZT and SOH require poling ferroelectric domains in order to have a net nonlinear electro optic (EO) response and/or to create a differential push-pull MZ modulator in some architectures. In order to achieve push-pull modulation in a MZ modulator, the material polarization and/or modulating radio frequency (RF) signals must be asymmetrically applied in the two arms of the modulator (parallel in one arm, anti-parallel in the other). If not, only one arm can be modulated.

For poling and biasing in BTO and other Pockels materials, for example, high electric fields must be applied to the Pockels layer. At the same time, aging phenomena in BTO and other Pockel materials can be accelerated by high electric fields. It is therefore desirable to avoid regions of concentration of high electric field, i.e., electric field crowding.

In a standard implementation of BTO-based MZ modulator, metal electrodes are placed in direct contact with BTO. With its high permittivity, this yields the high applied voltage drop in the BTO layer. Similar configurations exist in LN, PZT and SOH materials. These EO materials have a high permittivity compared to that of any surrounding cladding materials.

If BTO is kept as a blanket layer, and metal electrodes are deposited on the BTO layer, regions of concentration of high electric fields can be created at the interface between the inner corner of metal electrodes and the BTO layers.

The present invention concerns etching recessed contacts into the Pockels layer such as by partially removing the Pockels material, within the contact regions, and then forming the metal electrodes into the etched recesses. Ideally this recessed contact etching results in rounded corners.

A further innovation to minimize field crowding is by implementing rounded corners in the plane of the Pockels layer, i.e., when viewed from above.

Such structures result in a larger interfacial area between the metal electrode and the Pockels layer, leading to a distribution of the electric field over a larger area and therefore a significant decrease of aging phenomena. In general, regions of high electric field/current are more likely to suffer from increased ionic diffusion, electro-migration, current/field-induced interfacial chemical reactions forming lower-dielectric constant interfacial layers (e.g. metal oxides). These effects are likely to lead to premature catastrophic failure of BTO-based modulators but also LN and PZT devices, or result in increased bias drift which in turns decreases the lifetime of products based on these materials.

In general, these effects are pronounced in BTO modulators. BTO has a high permittivity (>1000), while in most materials the permittivity is an order of magnitude lower.

In general, according to one aspect, the invention features an electro-optic device comprising Pockels material, one or more waveguides on the Pockels material, one or more electrodes for phase modulating light propagating in the one or more waveguides, wherein at least one of the electrodes extends into the Pockels material.

In examples, an end of the electrodes has rounded corners. The end of the electrodes can also have a chiseled end. An end of the electrodes can also have rounded corners when viewed from above the Pockels material.

An optional passivation layer is sometimes used between the one or more waveguides and the Pockels material.

Often, the electrodes extend between 20-80% through a thickness of Pockels material, or more specifically between 50-70% through a thickness of Pockels material.

In general, according to another aspect, the invention features a method for fabricating electrodes in an electro-optic device including Pockels material. This method comprises forming one or more waveguides on the Pockels material, covering the waveguides with an upper cladding layer, forming via holes through the upper cladding layer and into the Pockels material, and forming electrodes in the via holes that extend into the Pockels material.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are top and schematic cross-sectional views showing an exemplary MZ modulator to which the present invention can be applied in one example;

FIGS. 2A, 2B, and 2C are schematic side cross sections and FIG. 2D is a top view showing the typical electrodes around a waveguide in a Pockels material, such as BTO;

FIGS. 3A, 3B, and 3C are schematic side cross sections and FIG. 3D is a top view showing the inventive electrodes around a waveguide in a Pockels material;

FIGS. 4A, 4B, 4C, and 4D show different profiles for the extended region of the electrode; and

FIGS. 5A and 5B show different undesired profiles for the extended region.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

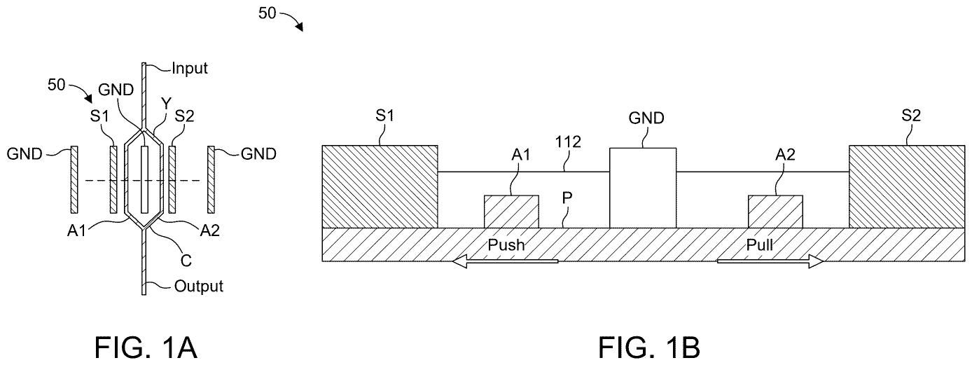

FIGS. 1A and 1B are top and cross-sectional views showing an exemplary modulator 50.

Pockels material P is arranged under MZ waveguides A1, A2. The modulator 50 further includes the input, Y-splitter Y, arms A1, A2, Y coupler or combiner C, and output.

In general, MZ modulators for transceivers, for example, are desired to be driven by an RF signal applied between signal electrodes (S1 and S2) and a center ground electrode GND to operate in a push-pull fashion; the modulating RF voltage advances the phase in one arm waveguide A1 while retarding the phase in the other arm waveguide A2.

As shown in the cross-section of FIG. 1B, the waveguides A1, A2 are buried under an upper cladding layer 112. The signal electrodes (S1 and S2) and possibly the center ground electrode GND project through the upper cladding layer 112 to enable electrical connections.

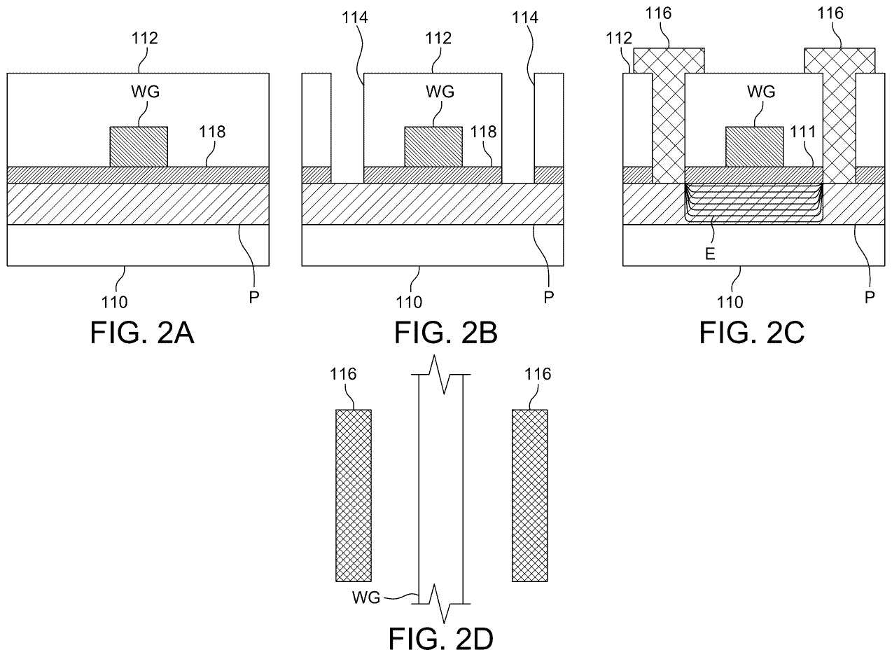

FIGS. 2A, 2B, and 2C are side cross sections and FIG. 2D is a top view showing the typical approach to fabricating electrodes 116 (such as signal electrodes (S1 and S2) and center ground electrode GND) around a waveguide WG (such as MZ waveguides A1, A2) in a Pockels material modulator 50.

In more detail, as shown in FIG. 2A, in the typical configuration, the Pockels material layer P is fabricated or bonded or otherwise located on a lower cladding layer 110, which itself usually sits on silicon wafer material. A passivation layer 118 often protects the Pockels layer P. A waveguide WG is fabricated and positioned on the passivation layer 118. Finally, the waveguide WG is surrounded by an upper cladding layer 112.

As shown in FIG. 2B, via holes 114 are then etched through the upper cladding layer 112 and through the passivation layer 118. This exposes the top of the Pockels layer P.

Then, as shown in FIG. 2C, typically metal electrodes 116 are fabricated in the via holes 114. Typically, they are deposited in a metallization process.

FIG. 2D is a top view of the electrodes 116. As shown, these electrodes are typically elongate, running parallel to the waveguide WG in the plane of the Pockels layer. The electrodes 116 are typically rectangular when looking from the top, i.e., orthogonal to the plane of the Pockels layer P.

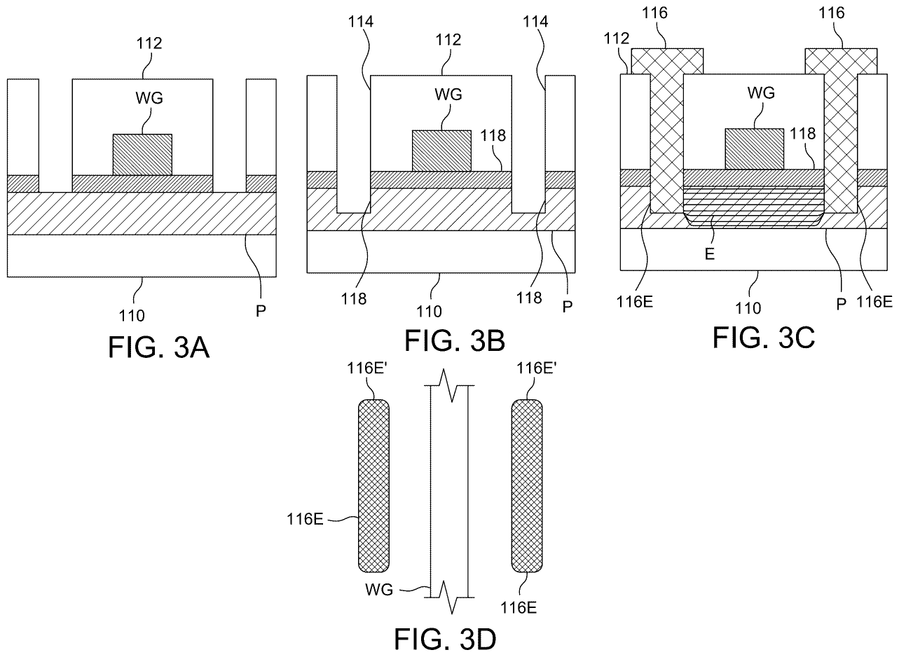

FIGS. 3A, 3B, and 3C are side cross sections and FIG. 3D is a top view showing the electrodes 116 fabricated according to the present invention.

FIG. 3A, corresponding to FIG. 2B, shows that the present approach works with the existing architecture.

It should be noted that the current approach employs the passivation layer 118. But, in other embodiments, the waveguide WG is directly in contact with the Pockels layer P.

However, as shown in FIG. 3B, the etch of the via holes 114 further extends into the Pockels layer P in the illustrated embodiment. Often, the first etch shown in FIG. 3A is a selective etch process using the Pockels material P as an etch stop. Then, a second etch is performed as shown in FIG. 3B to partially etch the Pockels layer P. This can be a timed wet etch that is selective for the Pockels material. A timed dry etch is another option. This produces extended via regions 118 of the via holes 114 that extend into the Pockels layer P.

Preferably, the extended via regions 118 extend between 20-80% through the thickness of Pockels layer P. More typically, the extended via regions 118 extend between 50-70% through the thickness of Pockels layer P. As a general rule, the deeper the better, but enough tolerance should be built-in so that the Pockels layer etch never gets completely through the Pockels layer.

In FIG. 3C, the electrodes 116 (such as signal electrodes (S1 and S2) and center ground electrode GND) then formed in the via holes 114 on either side of the WG (such as MZ waveguides A1, A2). The electrodes have extended electrode regions 116E that extend into the extended via regions 118 and thus into the Pockels layer P. Different materials can be used for the electrodes 116 including tungsten W, gold Au, titanium Ti, TiN, copper Cu, aluminum Al, AlCu, AlCuSi and any combinations of these. Still other options are doped silicon Si, indium tin oxide ITO (or other conducting transparent oxides), or other similar materials.

Since the electrodes 116 now have a larger surface area interface with the Pockels layer P, there is lower electric field E crowding in the Pockels layer P. Compare the electric field lines E in FIG. 3C against FIG. 2C.

A further innovation is shown in FIG. 3D. The corners of at least the extended electrode regions 116E, 116E of the electrodes 116 have rounded corners 116E′, 116E′ when viewed from above, or rounded in the plane defined by the Pockels layer P. This further reduces electric field crowding in the Pockels material P.

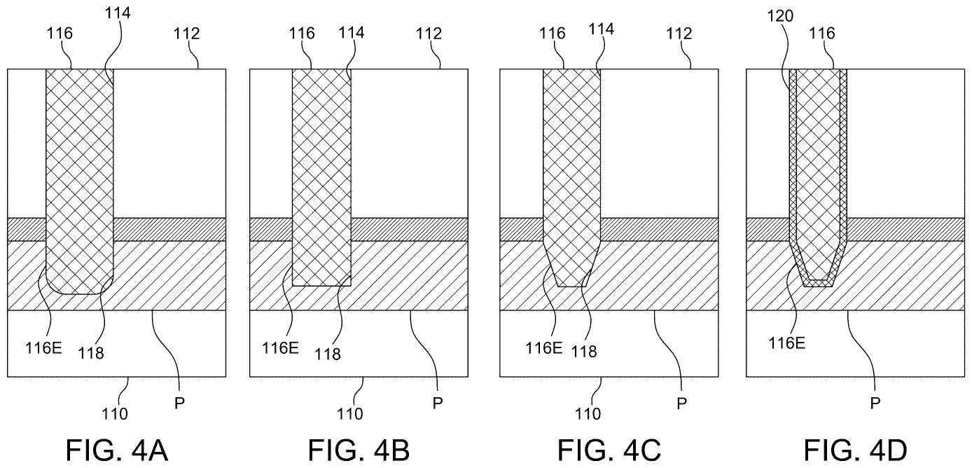

FIGS. 4A, 4B, 4C, and 4D show different profiles for the extended electrode region 116E of the electrode 116.

FIG. 4A shows an extended electrode region 116E with rounded corners at the end, filling in the extended via regions 118.

FIG. 4B shows an extended region 116E with squared corners at the end, filling in the extended via regions 118.

FIG. 4C shows an extended region 116E with a chiseled end, filling in the extended via regions 118.

FIG. 4D shows an extended region 116E with a chiseled end along with a metal barrier layer 120. Typically the metal barrier layer 120 is Ti, TiN, TiW and/or W or a dielectric barrier layer such as Al2O3, ZrO2 or TiO2. The layer is selected to improve reliability (minimize diffusion, chemical reactions) while maximizing the E-field penetration into Pockel layer.

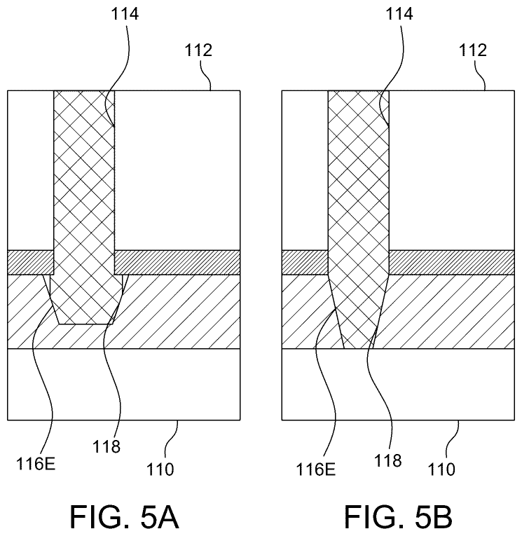

FIGS. 5A and 5B show two undesired profiles for the extended electrode region 116E of the electrode 116.

FIG. 5A shows an extended electrode region 116E with an underfilled condition of the extended via regions 118. Gaps between the electrode metal and the Pockels material P will disturb the formation of the electric fields in this critical area.

FIG. 5B shows an extended electrode region 116E extending all the way through the Pockels material P into the underlying lower cladding layer 110. This should be avoided because depending on the wet or dry etch recipe, stopping within the BTO layer implies that the wet/dry chemistry does not have to provide selectivity to the lower cladding material. Typically this is hard to achieve (etching BTO selectively to SiO2). So it is better to avoid etching through the BTO layer to have a more controllable manufacturing process.

While this invention has been particularly shown and described with references to preferred embodiments thereof, it will be understood by those skilled in the art that various changes in form and details may be made therein without departing from the scope of the invention encompassed by the appended claims.

1. An electro-optic device comprising:
Pockels material;
one or more waveguides on the Pockels material;
one or more electrodes for phase modulating light propagating in the one or more waveguides, wherein at least one of the electrodes extends into the Pockels material.

2. A device as claimed in claim 1, wherein an end of the electrodes has rounded corners.

3. A device as claimed in claim 1, wherein an end of the electrodes has a chiseled end.

4. A device as claimed in claim 1, wherein an end of the electrodes has rounded corners when viewed from above the Pockels material.

5. A device as claimed in claim 1, further comprising an optional passivation layer between the one or more waveguides and the Pockels material.

6. A device as claimed in claim 1, wherein the electrodes extend between 20-80% through a thickness of Pockels material.

7. A device as claimed in claim 1, wherein the electrodes extend between 50-70% through a thickness of Pockels material.

8. A method for fabricating electrodes in an electro-optic device including Pockels material, the method comprising:
forming one or more waveguides on the Pockels material;
covering the waveguides with an upper cladding layer;
forming via holes through the upper cladding layer and into the Pockels material; and
forming electrodes in the via holes that extend into the Pockels material.

9. A method as claimed in claim 8, wherein an end of the electrodes has rounded corners.

10. A method as claimed in claim 8, wherein an end of the electrodes has a chiseled end.

11. A method as claimed in claim 8, wherein an end of the electrodes has rounded corners when viewed from above the Pockels material.

12. A method as claimed in claim 8, further comprising an optional passivation layer between the one or more waveguides and the Pockels material.

13. A method as claimed in claim 8, further comprising forming via holes between 20-80% through a thickness of Pockels material.

14. A method as claimed in claim 8, further comprising forming via holes between 50-70% through a thickness of Pockels material.
